(19) United States
(12) Patent Application Publication
(10) Pub. No.: US 2012/0275587 A1
(43) Pub. Date: Nov. 1, 2012

(54) FACSIMILE MACHINE AND FACSIMILE FORWARD METHOD

(75) Inventor: CHIH-MING HSIEH, Tu-Cheng (TW)

(73) Assignee: HON HAI PRECISION INDUSTRY CO., LTD., Tu-Cheng (TW)

(21) Appl. No.: 13/448,498

(22) Filed: Apr. 17, 2012

(30) Foreign Application Priority Data
Apr. 26, 2011 (TW) 100114527

(51) Int. Cl. H04M 11/00

(52) U.S. Cl. 379/100.01

(57) ABSTRACT

A facsimile machine includes a receiving unit, a processing unit and a sending unit. The receiving unit receives facsimile data from a facsimile sending machine over a telephone network. The processing unit extracts a source identification number from the facsimile data and determines whether the source identification number matches one of a plurality of predetermined identification numbers. If the source identification number matches one of the predetermined identification numbers, the sending unit sends the facsimile data to a destination facsimile machine associated with a destination facsimile number over the telephone network.

### BACKGROUND

1. Technical Field

The disclosure generally relates to a facsimile machine and a method for forwarding facsimile data.

2. Description of Related Art

Multi-function peripherals (MFPs) including scanner units, printer units and facsimile units are popular because the MFPs are relatively small in size, have low noise and may perform color copying, printing, scanning, and transmitting facsimiles at low cost. The MFPs are capable of receiving facsimile data transmitted from facsimile sending machines over a public switched telephone network (PSTN), and printing the received facsimile data on sheets of paper. A user of an MFP may not always be the desired facsimile recipient, or the user may wish to forward the facsimile transmission to another recipient. Such a user may need to use the MFP to scan the printed paper file to retrieve the facsimile data and send the facsimile data to another recipient manually. Therefore, there is a need for a technique for automatically forwarding the facsimile data to another facsimile recipient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional block diagram of a multi-function peripheral (MFP) which is an example of a facsimile machine according to one embodiment.

FIG. 2 is a view illustrating one example of a structure of a facsimile transmission system according to one embodiment.

FIG. 3 is a flowchart showing a first embodiment of a method for forwarding facsimile data using the MFP of FIG. 1.

FIG. 4 is an example of a mapping table including predetermined source facsimile numbers according to the first embodiment.

FIG. 5 is a flowchart showing a second embodiment of a method for forwarding facsimile data using the MFP of FIG. 1.

FIG. 6 is an example of a mapping table including predetermined source facsimile numbers according to the second embodiment.

FIG. 7 is an example of a two-dimensional (2D) bar code comprised in facsimile data according to the second embodiment.

FIG. 8 is a flowchart showing a third embodiment of a method for forwarding facsimile data using the MFP of FIG. 1.

FIG. 9 is an example of a 2D bar code comprised in facsimile data according to the third embodiment.

FIG. 10 is an example of a mapping table including predetermined source identification numbers according to the third embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media comprise CDs, DVDs, BLU-RAY, flash memory, and hard disk drives.

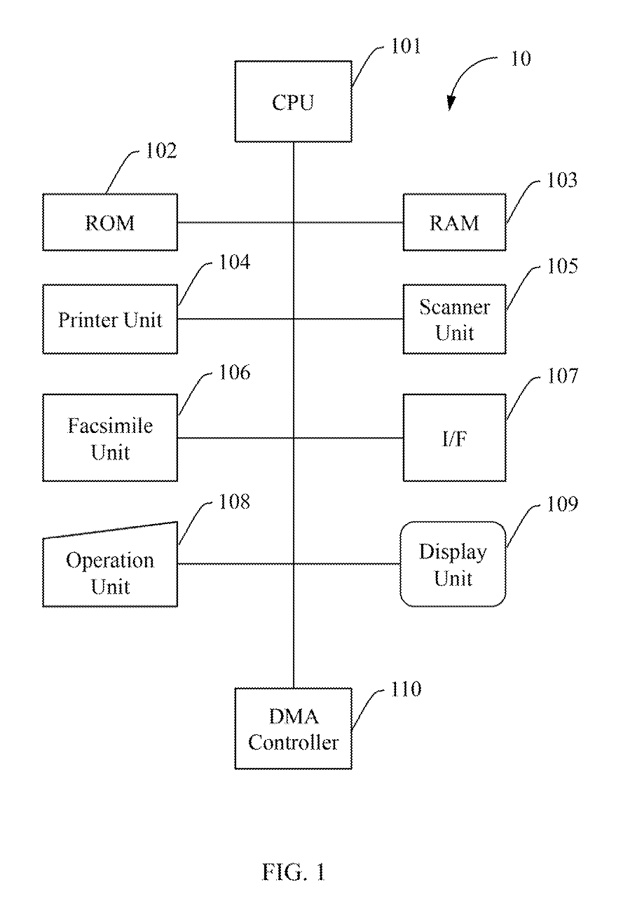

FIG. 1 is a functional block diagram of a multi-function peripheral (MFP) 10 which is an example of an image processing apparatus, according to one embodiment. The MFP 10 comprises a central processing unit (CPU) 101, a read only memory (ROM) 102, a random access memory (RAM) 103, a printer unit 104, a scanner unit 105, a facsimile unit 106, an interface (I/F) 107, an operation unit 108, a display unit 109, and a direct memory access (DMA) controller 110.

The CPU 101 is a processor for controlling the MFP 10 overall. The MFP 10 is controlled by running one or more programs (firmware) stored in the ROM 102.

The ROM 102 is non-volatile memory for storing the program(s) for controlling the MFP 10.

The RAM 103 is volatile memory which is used as a working area when the CPU 101 runs the program(s) stored in the ROM 102.

The printer unit 104 may print image data or facsimile data on a sheet of paper, an overhead projector (OHP) sheet, or the like (hereinafter, these will be referred to generically as a “printing medium”). In one embodiment, the printer unit 104 is an inkjet printer which comprises a printhead, a motor, and an ink cartridge. The printer unit 104 causes the ink carriage in the printhead to scan on the printing medium in a reciprocating manner, and to apply ink to the printing medium. Printing is performed by transporting the printing medium according to the scanning perpendicularly to the scanning direction of the carriage.

The scanner unit 105 may scan an image on a sheet of paper, a plastic sheet, a film, or any flat surface, and generate image data. The scanner unit 105 temporarily buffers, in the RAM 103, image data generated by scanned images.

The scanner unit 105 may comprise a scanner head which has a scanning width corresponding to an overall width of a largest readable medium (for example, A4-size paper). In the scanner head, a plurality of charge-coupled devices (CCDs) or a plurality of CMOS image sensors (CISs) may be arranged in the scanner head, in a line along the scanning width direction. Image data is obtained by the plurality of CCDs detecting light from the image, and converting the detected light into electrical signals. Further, the scanner head may be mechanically moved along a linear direction in a stepwise fashion by a motor of the scanner unit 105, with the linear direction being perpendicular to the line of the plurality of CCDs. An entire image is scanned by a combination of an electrical scanning of the plurality of CCDs and a mechanical movement of the scanner head. In the present disclosure, a direction of the electrical scanning performed by the line of the plurality of CCDs at any one time is called a “main scanning direction”, and the direction of the mechanical movement of the scanner head is called a “sub scanning direction.”

As described above, the scanner unit 105 may scan an image line-by-line, and may generate color image data. The color image data is image data in which the color components including red, green, and blue (RGB) components are represented in, for example, 8 bits (0 to 255). A number of bits representing each pixel can be freely set within a capability range of the plurality of CCDs or the plurality of CISs. The number of bits representing each pixel is called “image level” or “color depth.”

The facsimile unit 106 may receive facsimile data transmitted from a facsimile sending machine or send facsimile data to a destination facsimile machine over a public switched telephone network (PSTN). The RAM 103 is also used as buffer memory for temporarily storing the facsimile data.

The I/F 107 is an interface for allowing the MFP 10 to communicate with various external devices. The external devices may comprise, for example, a personal computer (PC), and a drive for reading and writing data in a storage medium such as a memory card. The I/F 107 may comprise USB and IEEE 1394 capabilities.

The operation unit 108 may be operated by a user to provide the MFP 10 with various instructions. An instruction may comprise, for example, a scan instruction for causing the scanner unit 105 to perform scanning, a print instruction for causing the printer unit 104 to perform printing on a printing medium, and a facsimile instruction for causing the facsimile unit 106 to send facsimile data to a facsimile receiving machine over the PSTN. The instruction to the MFP 10 may be provided from a PC, or the like, through the I/F 107.

The display unit 109 may notify the user of various information, and comprises an LCD, an LED, or the like. The various information provided to the user may comprise, for example, a state of the MFP 10 (scanning, printing, faxing, or idling), and a setting menu of the MFP 10.

The DMA controller 110 is a controller for transferring data between constituent elements of the MFP 10.

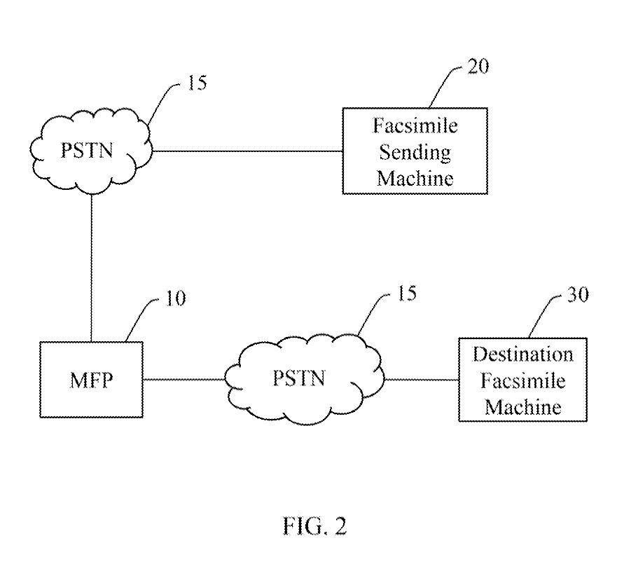

FIG. 2 illustrates one example of a structure of a facsimile transmission system according to one embodiment. The MFP 10 may receive facsimile data transmitted from a facsimile sending machine 20 over a PSTN 15 and send the same or other facsimile data to a destination facsimile machine 30 over the PSTN 15.

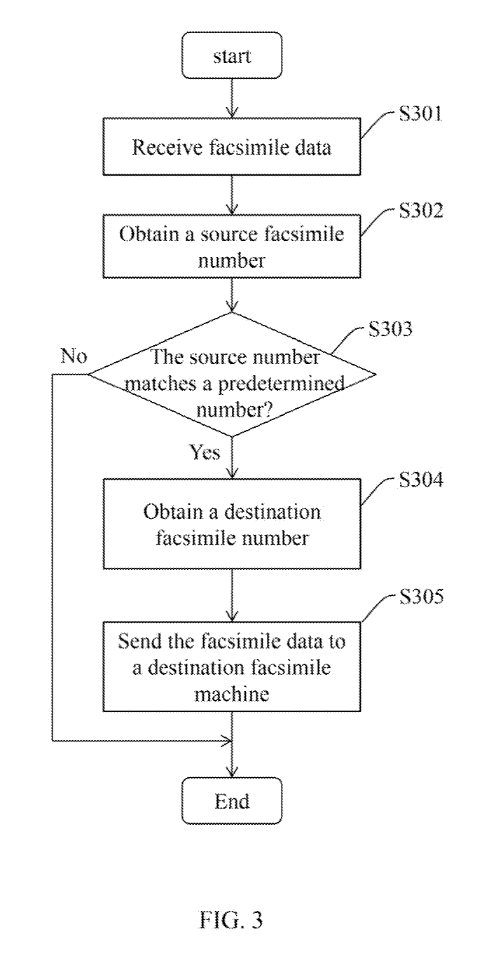

FIG. 3 is a flowchart showing a first embodiment of a method for forwarding facsimile data using the MFP 10 of FIG. 1. The method may comprise the following steps.

In step S301, the facsimile unit 106 receives facsimile data transmitted via the PSTN 15 from the facsimile sending machine 20.

In step S302, the MFP 10 obtains a source facsimile number of the facsimile sending machine 20.

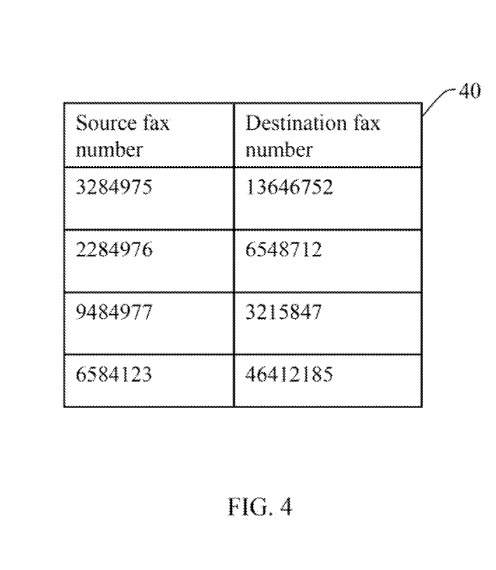

In step S303, the MFP 10 determines whether the source facsimile number of the facsimile sending machine 20 matches a pre-stored source facsimile number stored in a mapping table 40. FIG. 4 shows an example of the mapping table 40. The mapping table 40 comprises a plurality of pre-stored source facsimile numbers and a plurality of destination facsimile numbers, each of which corresponds to one of the plurality of pre-stored source facsimile numbers. The MFP 10 compares the source facsimile number of the facsimile sending machine to each of the plurality of pre-stored source facsimile numbers in the mapping table 40. If the source facsimile number of the facsimile sending machine 20 matches one of the plurality of pre-stored source facsimile numbers, the flow goes to step S304. If the source facsimile number of the facsimile sending machine 20 does not match any of the plurality of pre-stored source facsimile numbers, a facsimile receiving process from the facsimile sending 20 machine is complete.

In step S304, the MFP 10 obtains from the mapping table 40 a destination facsimile number corresponding to the source facsimile number of the facsimile sending machine 20.

In step S305, the facsimile unit 106 sends the facsimile data to a destination facsimile machine associated with the destination facsimile number.

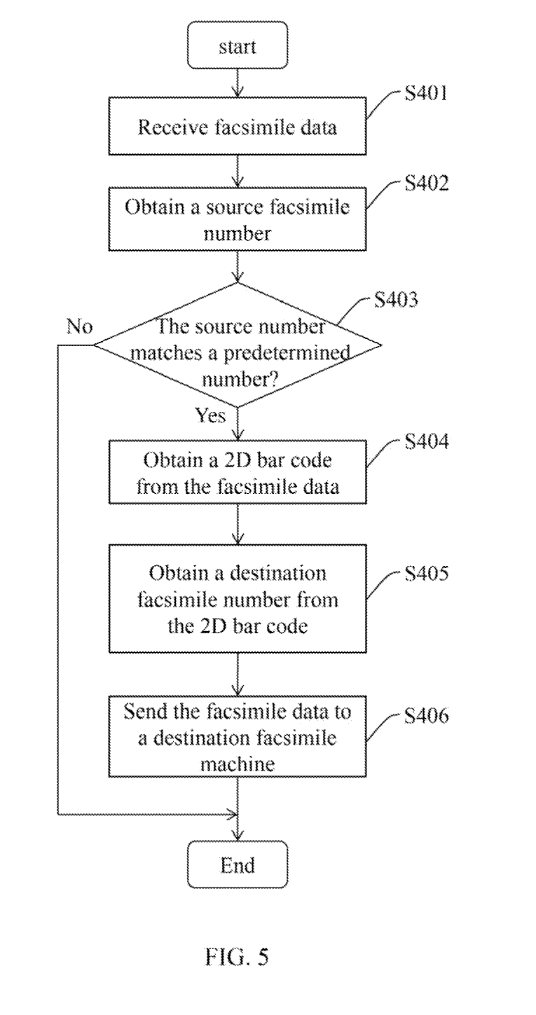

FIG. 5 is a flowchart showing a second embodiment of a method for forwarding facsimile data using the MFP 10 of FIG. 1. The method may comprise the following steps.

In step S401, the facsimile unit 106 receives facsimile data transmitted from the facsimile sending machine 20 over the PSTN 15.

In step S402, the MFP 10 obtains a source facsimile number of the facsimile sending machine 20.

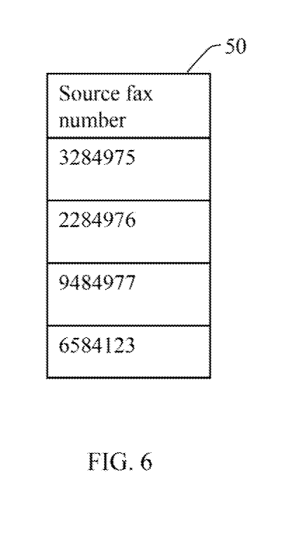

In step S403, the MFP 10 determines whether the source facsimile number of the facsimile sending machine 20 matches a pre-stored source facsimile number in a mapping table 50. FIG. 6 shows an example of the mapping table 50. The mapping table 50 comprises a plurality of pre-stored source facsimile numbers. The MFP 10 compares the source facsimile number of the facsimile sending machine 20 to the pre-stored source facsimile numbers in the mapping table 50. If the source facsimile number of the facsimile sending machine 20 matches one of the pre-stored source facsimile numbers, the flow goes to step S404. If the source facsimile number of the facsimile sending machine 20 does not match any of the pre-stored source facsimile numbers, a facsimile receiving process from the facsimile sending 20 machine is complete.

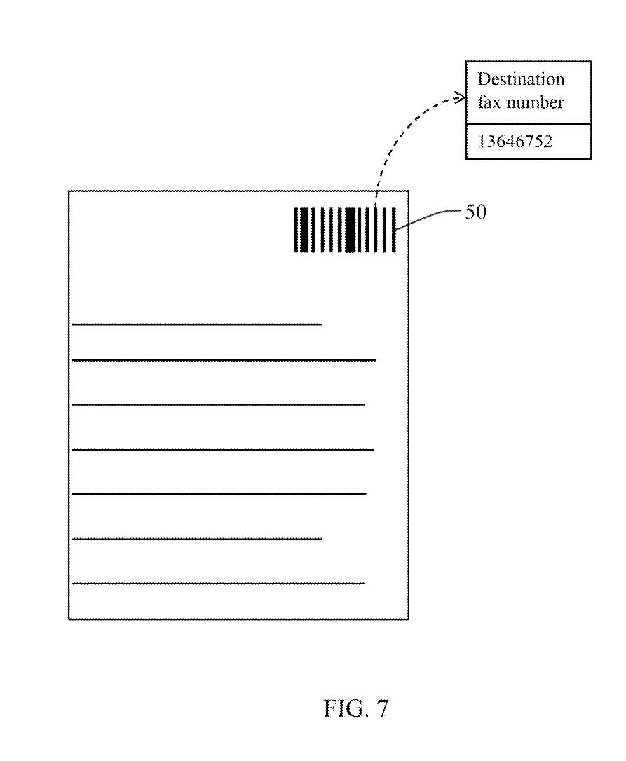

In step S404, the MFP 10 obtains a two-dimensional (2D) bar code from the facsimile data. FIG. 7 shows an example of a 2D bar code 50 comprised in the facsimile data according to the second embodiment. The 2D bar code 50 comprises a destination facsimile number. The 2D bar code may be extracted from the fax data and be recognized in a digital form.

In step S405, the MFP 10 decodes the destination facsimile number from the 2D bar code 50.

In step S406, the facsimile unit 106 sends the facsimile data to a destination facsimile machine having the decoded destination facsimile number.

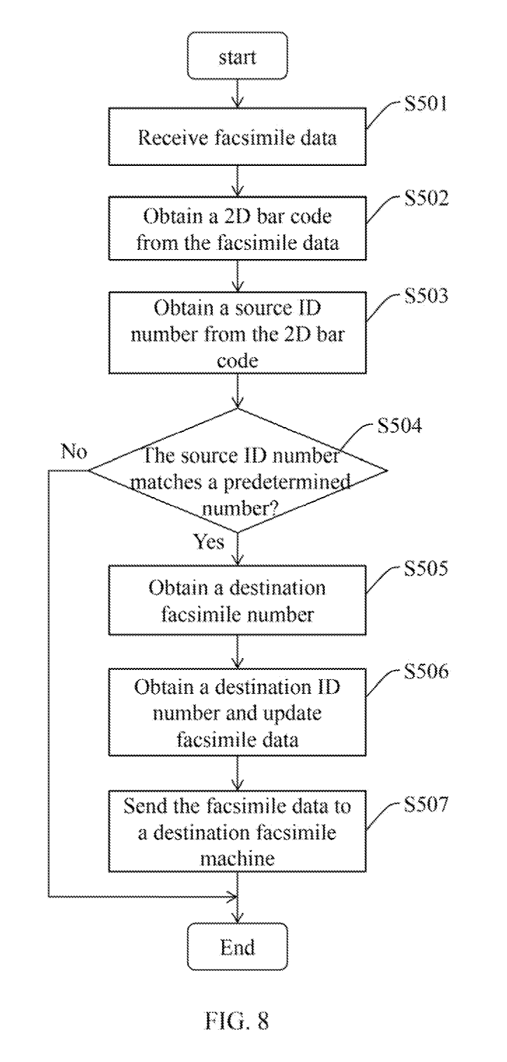

FIG. 8 is a flowchart showing a third embodiment of a method for forwarding facsimile data using the MFP 10 of FIG. 1. The method may comprise the following steps.

In step S501, the facsimile unit 106 receives facsimile data transmitted from the facsimile sending machine 20 over the PSTN 15.

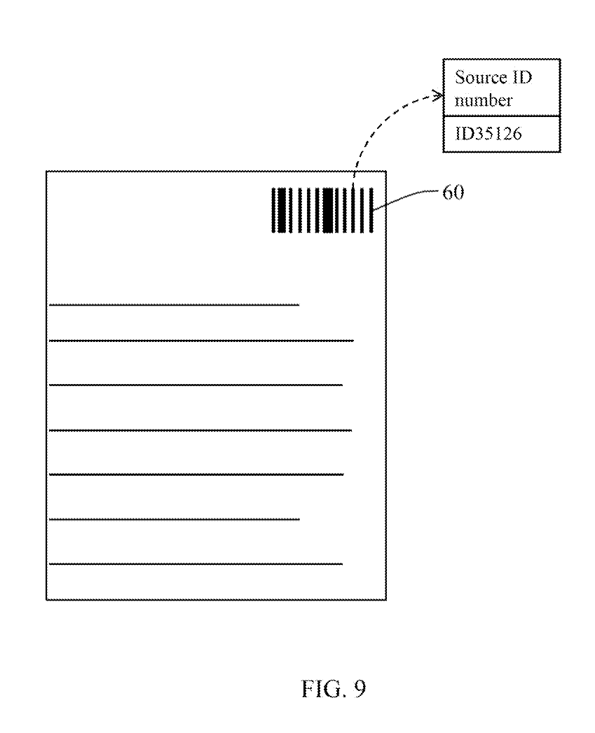

In step S502, the MFP 10 obtains a two-dimensional (2D) bar code from the facsimile data. FIG. 9 shows an example of a 2D bar code 60 comprised in the facsimile data according to the third embodiment. The 2D bar code 60 comprises a source identification number.

In step S503, the MFP 10 decodes a source identification number from the 2D bar code 60.

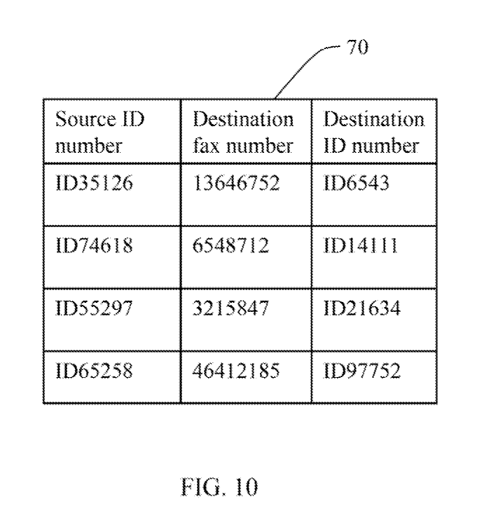

In step S504, the MFP 10 determines whether the source identification number matches a pre-stored source identification number stored in a mapping table 70. FIG. 10 shows an example of a mapping table 70. The mapping table 70 comprises a plurality of pre-stored source identification numbers, a plurality of destination facsimile numbers and a plurality of destination identification numbers. Each of the destination facsimile numbers and each of the destination identification numbers correspond to one of the pre-stored source identification numbers. The MFP 10 compares the source identification number to the pre-stored identifications in the mapping table 70. If the source identification number matches one of the pre-stored source identification numbers, the flow goes to step S505. If source identification number of the facsimile sending machine 20 does not match any of the pre-stored source identification numbers, a facsimile receiving process from the facsimile sending 20 machine is complete.

In step S505, the MFP 10 obtains from the mapping table 70 a destination facsimile number corresponding to the source identification number of the facsimile sending machine 20.

In step S506, the MFP 10 obtains from the mapping table 70 a destination identification number corresponding to the source identification number of the facsimile sending machine 20 and update the facsimile data by replacing the source identification number with the destination identification number.

In step S507, the facsimile unit 106 sends the updated facsimile data to a destination facsimile machine associated with the destination facsimile number.

Although numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn for or in relation to a method may comprise some indication in reference to certain steps. However, any indication used is only to be viewed for identification purposes and not as a suggestion as to an order for the steps.

What is claimed is:

1. A facsimile forward method, the facsimile forward method comprising:
receiving facsimile data from a facsimile sending machine over a telephone network;
extracting a source identification number from the facsimile data;
determining whether the source identification number matches one of a plurality of predetermined identification numbers; and
sending the facsimile data to a destination facsimile machine associated with a destination facsimile number over the telephone network, when the source identification number matches one of the plurality of predetermined identification numbers.

2. The facsimile forward method of claim 1, wherein the extracting comprises obtaining a two-dimensional bar code from the facsimile data, and obtaining the source identification number from the two-dimensional bar code.

3. The facsimile forward method of claim 1, further comprising updating the facsimile data by replacing the source identification number with a destination identification number before the step of sending the facsimile data to the destination facsimile machine.

4. The facsimile forward method of claim 1, further comprising storing the plurality of predetermined identification numbers in a mapping table.

5. The facsimile forward method of claim 4, wherein the mapping table further comprises a plurality of destination facsimile numbers, each of the plurality of destination facsimile numbers corresponds to one of the plurality of predetermined identification numbers, and the method further comprises obtaining the destination facsimile number corresponding to the source identification number from the mapping table.

6. The facsimile forward method of claim 4, wherein the mapping table further comprises a plurality of destination identification numbers, each of the plurality of destination identification numbers corresponds to one of the plurality of predetermined identification numbers, and the method further comprises:
obtaining a destination identification number corresponding to the source identification number from the mapping table; and
updating the facsimile data by replacing the source identification number with the destination identification number before the step of sending the facsimile data to the destination facsimile machine.

7. A facsimile machine, comprising:
a facsimile receiving unit adapted to receive facsimile data from a facsimile sending machine over a telephone network;
a processing unit adapted to extract a source identification number from the facsimile data and determine whether the source identification number matches one of a plurality of predetermined identification numbers; and
a facsimile sending unit adapted to send the facsimile data to a destination facsimile machine associated with a destination facsimile number over the telephone network, when the source identification number matches one of the plurality of predetermined identification numbers.

8. The facsimile machine of claim 7, wherein the processing unit is further adapted to obtain a two-dimensional bar code from the facsimile data and obtain the source identification number from the two-dimensional bar code.

9. The facsimile machine of claim 7, wherein the processing unit is further adapted to update the facsimile data by replacing the source identification number with a destination identification number before the facsimile data is sent to the destination facsimile machine.

10. The facsimile machine of claim 7, the facsimile machine comprises a mapping table adapted to store the plurality of predetermined identification numbers.

11. The facsimile machine of claim 10, wherein the mapping table further comprises a plurality of destination facsimile numbers, each of the plurality of destination facsimile numbers corresponds to one of the plurality of predetermined identification numbers, and the processing unit is further adapted to obtain the destination facsimile number corresponding to the source identification number from the mapping table.

12. The facsimile machine of claim 10, wherein the mapping table further comprises a plurality of destination identification numbers, each of the plurality of destination identification numbers corresponds to one of the plurality of predetermined identification numbers, and the processing unit is further adapted to obtain a destination identification number corresponding to the source identification number from the mapping table and update the facsimile data by replacing the source identification number with the destination identification number before the facsimile data is sent to the destination facsimile machine.

13. A facsimile forward method, the facsimile forward method comprising:
receiving facsimile data from a facsimile sending machine over a telephone network;
obtaining a source facsimile number of the facsimile sending machine;
determining whether the source facsimile number matches one of a plurality of predetermined source facsimile numbers; and
sending the facsimile data to a destination facsimile machine associated with a destination facsimile number over the telephone network, when the source facsimile number matches one of the plurality of predetermined source facsimile numbers.

14. The facsimile forward method of claim 13, further comprising storing the plurality of predetermined source facsimile numbers in a mapping table.

15. The facsimile forward method of claim 14, wherein the mapping table further comprises a plurality of destination facsimile numbers, each of the plurality of destination facsimile numbers corresponds to one of the plurality of predetermined source facsimile numbers, and the method further comprises obtaining the destination facsimile number corresponding to the source facsimile number from the mapping table.

16. The facsimile forward method of claim 13, further comprising obtaining the destination facsimile number from the facsimile data.

17. The facsimile forward method of claim 13, further comprising obtaining a two-dimensional bar code from the facsimile data and obtaining the destination facsimile number from the two-dimensional bar code.
